(19) United States
(12) Patent Application Publication
(10) Pub. No.: US 2012/0227470 A1
(43) Pub. Date: Sep. 13, 2012

(54) Chromatography Apparatus Having An Integrated Core

(75) Inventors: Geoff C. Gerhardt, Millbury, MA (US); Anthony C. Jeannotte, Foxborough, MA (US); Theodore A. Dourdeville, Marion, MA (US); Lynda Neue, Ashland, MA (US); Uwe Dieter Neue, Ashland, MA (US)

(73) Assignee: WATERS TECHNOLOGIES CORPORATION, Milford, MA (US)

(21) Appl. No.: 13/375,644

(22) PCT Filed: Jun. 11, 2010
(86) PCT No.: PCT/US10/38288

§ 371 Date: May 25, 2012

Related U.S. Application Data
(60) Provisional application No. 61/220,713, filed on Jun. 26, 2009.

(51) Int. Cl. G01N 30/20

(52) U.S. Cl. 73/61.56

(57) ABSTRACT

A chromatography apparatus includes a sample-delivery patterned substrate and a tube-based separation column directly connected to an outlet port of the patterned substrate. The patterned substrate includes an injector valve connected to the outlet port.

### CROSS REFERENCE TO RELATED APPLICATION

This application claims priority to U.S. Provisional Application No. 61/220,713, filed Jun. 26, 2009, the entirety of which is incorporated herein by reference.

### FIELD OF THE INVENTION

The invention relates generally to chromatography. More specifically, the invention relates to apparatus and methods that reduce dispersion caused by extra-column band spreading.

### BACKGROUND

High-performance liquid-chromatography (HPLC) and ultra-high-performance liquid-chromatography (UHPLC) instruments are tools used to separate, identify, and/or quantify compounds in samples. Traditional HPLC instruments use analytical columns constructed from stainless-steel tubing. A typical column is formed from tubing having an inner bore diameter of 4.7 mm, with a length in a range of approximately 5 cm to approximately 25 cm.

Many factors affect the spectral resolution afforded by a particular instrument. One such factor is the band spreading of sample components, as the components flow through the instrument. Loss of resolution due to band spreading can arise from a number of effects, for example, volumetric effects, time-based events (sampling rate) and solvent gradient-delay volume. To achieve optimal separation efficiency, an appropriate flow rate of a mobile phase is important.

In an HPLC instrument, an injector is typically used to inject a sample into a flowing mobile phase as a discrete fluidic plug. Dispersion of a plug band as it travels to and/or from the column has the potential to reduce the ultimate efficiency of the chromatographic system. For example, in a chromatographic system using 4.7 mm column tubing packed with 5 μm diameter particles, and a mobile phase flowing at 1-2 mL/min, connecting tubing having an outer diameter of 1/16 inch and an inner diameter of about 0.010 inch is typically used to plumb connections between the various HPLC components (e.g. pump, injector, column, and detector). For these flow rates and tubing dimensions, it is relatively easy to machine port details to tolerances that will provide acceptably minimal band broadening at tubing interfaces.

Some instruments are configured to accommodate smaller sample volumes or to reduce mobile-phase solvent consumption; such configurations may entail a reduction in column inner diameter (ID). Thus, several scales of chromatography are now commonly practiced; these are typically defined as shown in Table 1.

TABLE 1

| HPLC Scale | Column ID | | Typical Flow range | |
|---|---|---|---|---|
| Analytical | 4.7 | mm | 1 | s mL/min |
| Microbore | 1-2 | mm | 100 | s μL/min |
| Capillary | 300-500 | μm | 10 | s μL/min |
| Nano | 50-150 | μm | 100 | s nL/min |

Microbore HPLC has often been practiced with equipment similar to that used for analytical scale HPLC, with minor modifications. It is generally assumed that, aside from requiring a small degree of additional care in making fittings, microbore HPLC requires an operating-skill level similar to that of analytical scale HPLC.

In contrast, capillary and nano-scale HPLC require relatively significant changes in HPLC components relative to analytical-scale HPLC. Generation of stable mobile-phase flows of less than about 50 μL/min is relatively difficult using standard open-loop reciprocating HPLC pumps, such as those commonly found in analytical and microbore HPLC systems.

For capillary-scale chromatography, stainless-steel tubing is usable for component interconnections; however, the inner diameter must typically be less than 0.005 inch (less than about 125 μm). Care is generally required in the manufacture of fitting terminations to avoid creation of even minute amounts of dead volume.

For nano-scale chromatography, tubing having inner diameters of about 25-50 μm is typically required to interconnect components of an instrument (e.g., to connect a pump to a separation column). Because stainless-steel tubing is typically unavailable in these dimensions, polyimide-coated fused-silica tubing is typically used. Although fused-silica tubing has excellent dimensional tolerances and very clean, non-reactive interior walls, it is fragile and can be difficult to work with. In addition, interconnection ports should be machined to exacting tolerances to prevent even nanoliters of unswept dead volume.

While the primary motivation to replace analytical-scale HPLC with microbore-scale HPLC may be the desire for reduced solvent consumption, moving to capillary-scale and nano-scale chromatography can support improved detection sensitivity for mass spectrometers, in addition to further reducing solvent consumption, when, for example, flows of less than about 10 μL/min are used. Moreover, capillary-scale or nano-scale systems are often the only options for the sensitive detection typically required for applications involving small amounts of available sample (e.g., neonatal blood screening).

Despite the advantages of capillary-scale and nano-scale chromatography, HPLC users tend to employ microbore-scale and analytical-scale chromatography systems. As described above, these systems typically provide good reliability and relative ease-of-use. In contrast, maintenance of good chromatographic efficiency while operating a capillary-scale or nano-scale chromatographic system requires significant care when plumbing the system (e.g., using tubing to connect pump, injector, column, and detector).

### SUMMARY

Some embodiments arise from the realization that some UHPLC apparatus do not realize their full resolution potential, due to extra-column band broadening caused by various common LC plumping-related components, detection-related components and/or the plumbing used to connect various components. Further, some embodiments arise, in part, from a realization that volumetric band spreading in a very-high-pressure chromatography apparatus that uses a tube based column can be substantially reduced by partial integration of fluid-handling components and direct connection of the column's inlet and/or outlet with partially integrated components. For example, an injector valve integrated in a patterned substrate can be directly connected to an inlet of a separation column to reduce or eliminate band spreading associated with a connection tube and/or two connectors associated with the tube.

Thus, for example, to realize the efficiencies possible with sub-2 μm packed columns, and columns with ID of less than 4.7 mm, the pre- and post-column dispersion caused by connecting the various modules of a standard HPLC system are optionally eliminated or substantially reduced through integration of components, thus reducing dispersion caused by connectors and/or eliminated plumbing components. Furthermore, because the higher efficiencies afforded by these sub-2 μm packed columns can be used to run faster analyses, elimination of the volumes contained in the connection tubing would enable faster analysis times.

Moreover, a partially integrated apparatus is optionally configured with a swappable core, where the core includes components tailored to particular flow rates and/or volumes, while associated fixed components support all cores.

Some preferred embodiments entail mass analysis.

Accordingly, one embodiment features a chromatography apparatus. The apparatus includes a core unit including a tube-based separation column. The core unit also includes a sample-delivery patterned substrate, which includes an injector valve and a sample outlet port in fluidic communication with the injector valve. An inlet end of the separation column is directly connected to the sample outlet port of the patterned substrate. The core optionally includes a detection patterned substrate, which includes a detector and an eluent inlet port in fluidic communication with an inlet of the detector. An outlet end of the tube is directly connected to the eluent inlet port.

### BRIEF DESCRIPTION OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating principles.

FIG. 1A is a block diagram of a prior-art modular HPLC system.

FIG. 1B is a graph of measured resolution versus retention factor.

FIG. 1C is a graph of measured resolution versus retention factor.

FIG. 2 is a block diagram of a chromatography apparatus, according to one embodiment.

FIG. 3 is a block diagram of a chromatography apparatus, according to one embodiment.

FIG. 4 is a three-dimensional view of a detailed embodiment of a core unit of an apparatus, according to one embodiment.

FIG. 5 is an exploded three-dimensional view of the sample-delivery patterned substrate of FIG. 4.

FIG. 6 is a cross-sectional detailed view of a portion of the core unit of FIG. 4.

FIG. 7A is a planar view of a rotor having three surface grooves.

FIG. 7B is a planar view of a stator surface layer, for contacting the rotor of FIG. 7A.

FIG. 7C is a planar view of a sample-loop layer.

FIG. 7D is a planar view of a conduit layer.

FIG. 8 is a cross-sectional view of a flow-cell portion of one alternative implementation of the detection unit of FIG. 4, for absorbance-based optical analysis.

FIG. 9A is an end view of an inlet or outlet element.

FIG. 9B is a side view of the inlet or outlet element of FIG. 9A.

FIG. 9C is a side view of the inlet or outlet element of FIG. 9A, illustrating fabrication of the element.

FIG. 10 is a cross-sectional view of an output end of the flow cell of FIG. 8.

### DETAILED DESCRIPTION

Some embodiments mitigate the effects volumetric band spreading to permit realization of substantially more of the potential resolution provided by UHPLC (ultra-high-performance liquid chromatography.)

Numerous embodiments of the present invention are possible and will be apparent to those skilled in the art, given the benefit of this disclosure. The detailed description provided herein, for convenience, will focus on a few illustrative and exemplary embodiments. In view of this description, one of skill will understand that various other embodiments are possible.

As used here, the term “fluid” refers to gases, liquids, supercritical fluids and the like, optionally containing dissolved species, solvated species and/or particulate matter. Analysis of a fluid, as used herein, has a broad meaning, including any detection, measurement or other determination of the presence of a fluid or of a characteristic or property of the fluid or of a component of the fluid, such as particles, dissolved salts or other solutes or other species in the fluid, or separation of a component for, for example, purposes of purification and collection. Preferred embodiments relate to liquid-based separation.

As used here, the terms “patterned substrate” and “patterned module” refer to a component that includes fluidic pathways formed, at least in part, by one or more patterning processes, such as stamping, laser ablation, chemical etching, and embossing. A patterned substrate is optionally formed of two or more stacked layers, at least one of which is patterned, or optionally includes one or more portions of a non-rectangular-solid shape. Preferred materials include ceramics and/or metals, and metal-based apparatus are particularly suited to fabrication from layers, foils and/or bulkier portions. A ceramic-based substrate is preferably formed, in part, by patterning and sintering, and a metal-based substrate is preferably formed, in part, by patterning and diffusion bonding. A patterned substrate is patterned with fluidic features of any desired dimension(s). Some embodiments of the invention include one or more patterned substrates or modules having components defined in and/or on and/or embedded, in and/or on, and/or attached to the substrate or module; for example, some embodiments include a substrate having an embedded flow cell. Some embodiments are optionally fabricated using diffusion-bonding-based methods described in PCT International Publication No. WO 2008/106613, inventor Dourdeville and/or green-ceramic-based methods described in US Patent Application Publication No. 2009/0321356, inventors Gerhardt et al.

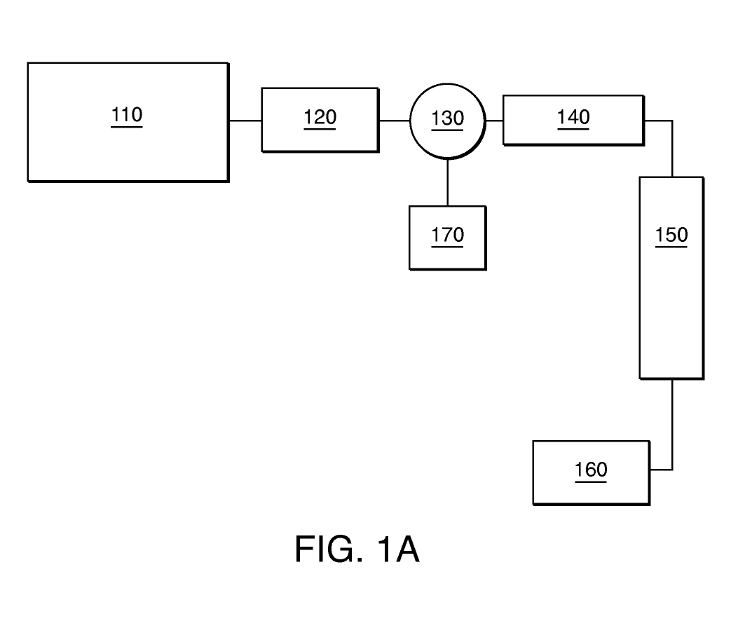

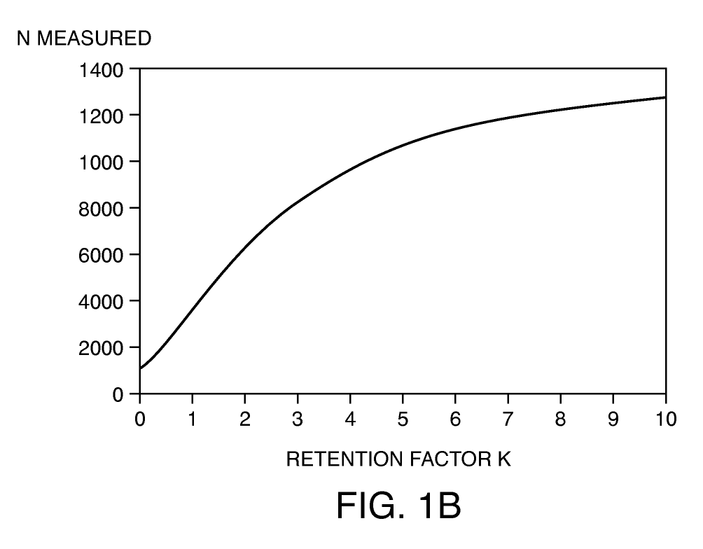

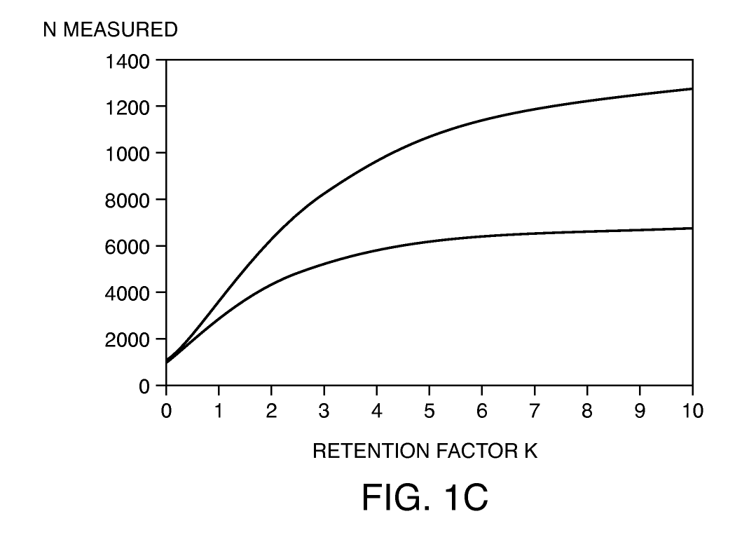

FIG. 1A is a block diagram of a prior-art modular HPLC system 100. The system includes a solvent-supply module 110, a solvent mixer 120, a sample injector 130, a sample manager 170, a pre-column heater 140 (to heat liquid before it enters an analytical column,) an analytical column 150 and a detector 160. Tubing and associated connectors fluidicly connect the various modules 110, 120, 130 140, 150, 160. Such plumbing typically adds system volume that both lengthens analysis times and adds dispersion. The column 150 has a length of, for example, 5 cm.

HPLC is generally thought of as a relatively mature analytical technique that has evolved since its introduction, for example, with the development of separation columns having ever increasing resolving power. The most common separation mode, using a packed bed of particles, has been improved significantly. For example, particles with optimized porosity and reduced particle size (such as a 1.7 μm diameter,) to improve the kinetics of interaction of the sample analyte with the stationary phase, have been developed. What may not be well recognized is the difficulty that the typical modular approach to instrument design imposes on realization of the full resolution potential offered by use of relatively small particles and relatively high pressures.

Well-defined samples plugs are preferably formed and delivered to a separation column, at speeds that optimize the high duty cycle afforded by these improved separation devices. Moreover, a detection module preferably provides high-speed reporting frequency, to enable sufficient sampling of high-frequency eluted zones, has detection volumes scaled to reduced peak volumes, and has a concentration-proportional response that spans the loadability range of the separation device.

While significant progress has been made in developing highly efficient separation modules, some existing LC system modules and related plumbing struggle to both load these separation devices with well-defined sample zones and then subsequently transport the eluted zones to a detector without adding dispersion that degrades the ultimate chromatographic performance of the system.

While some existing injection systems that can create well-defined sample plugs, typical existing tubing interconnections are not capable of maintaining the integrity of a small-volume, well-formed sample plug during its delivery to a separation device. Existing systems typically use drawn stainless-steel tubing to connect the separation device to injection and detection systems. While this type of tubing has provided a robust and relatively inert connection solution for LC applications, it is generally becoming increasingly difficult to find sources of metal tubing with internal diameters demanded by the increased separation efficiencies made available by recently developed small-diameter particles.

For some current state-of-the-art separation systems that use sub-2 μm chromatographic particles, preservation of a sample plug and eluted zone fidelity could require tubing inner diameter (ID) of ≦75 μm. This is generally at or beyond the limit of current tubing manufacturing capabilities.

Metal tubing is typically created by drawing down tubing of larger ID. When this drawing process is used to create tubing with an ID of ≦100 μm, it typically creates a tube with a poorly-formed internal surface. These poorly-formed internal tubing surfaces generally add dispersion. While smooth-walled fused-silica tubing is available that would give superior performance over such metal tubing, it is generally relatively fragile and difficult to interface, particularly at the high fluidic pressures (e.g., >15,000 psi) typically required by sub-2 μm chromatographic particles. Furthermore, each tubing interface is a potential dispersion source as it is a challenge to create tubing interfaces that can be repeatedly made in a reliable manner, with the required low unswept volumes.

Some prior art systems often do not realize their theoretical potential resolution. For example, the column 150 has a theoretical resolution of approximately 14,000 to 15,000 plates. Extra-column band spreading, however, often greatly diminishes performance, at least when the system 100 is not utilizing relatively high retention factors.

Some preferred embodiments, described below, permit realization of a greater degree of the theoretical chromatographic resolution promised by presently available narrow-ID columns packed with relatively small particles and intended for high-pressure operation. Existing systems can impair potential column resolution due to extra-column effects. Such effects include volumetric bandspreading, time-based bandspreading, i.e., sampling-rate effects, and solvent-gradient delay effects. The following description focuses on embodiments that mitigate volumetric effects.

The following description is provided for an illustrative and non-limiting review of dispersion effects, and their mitigation. To obtain one optional measure of band spreading, with which to assess system performance, one may measure the width of a chromatographic peak at 4.4% of peak height to obtain a peak width corresponding to 5 times the standard deviation of the peak width (units of time), i.e., 5σ. From this quantity, a band-spreading volume is optionally calculated by multiplying the measured peak width, 5σ, by the flow rate. More commonly, peak width is equated with the 1σ width of a peak. The 1σ width generally provides a better estimate of peak broadening.

Many portions of exiting systems introduce physical effects that potentially contribute to this band-spreading of peaks typically observed in LC spectra; such portions may include, for example: injector, injector-to-column tubing; column including frits; column-to-detector tubing (and associated connectors); and detector cell. The combined effect of these contributors is optionally estimated by summing the squares of the variances (the standard deviations) of each contribution.

Thus, without attempting to reduce band-spreading caused by the column, one may attempt to reduce extra-column band spreading by reducing the length and/or diameter of tubing used to plumb a system. Such an approach to dispersion reduction, however, is restricted by, for example, the ability and desirability of packing the various modules 110, 120, 130 140, 150, 160 closer together and/or reducing plumbing cross sections.

As mentioned, a detector cell can contribute to dispersion. Generally, selection of an optimum flow-cell volume varies with peak volume, which, in turn, varies with column diameter. Moreover, peak volumes typically increase during a chromatographic run (that is, later eluters have a greater volume than earlier eluters.) Thus, though an optimum cell volume, to balance sensitivity and dispersion, is, for example, 1/10 a peak volume, such a volume cannot be accommodated for all sample-component peaks, when all eluting components flow through a fixed cell volume.

Table 2 shows estimates of eluent-component peak volumes (Vₚₖ) for separation columns of different IDs, and flow-cell volumes (V_{cell}) corresponding to 1/10 the estimated volume of relatively early-eluting components. Though not intended to confine the invention to features of any specific dimensions, Table 2 illustrates, in this example, that: a 2.1 mm column has, for example, early eluters with a peak volume of 16 uL and late eluters with a peak volume of 39 uL; a 1.0 mm column has, for example, early eluters with a peak volume of 3.7 uL and late eluters with a peak volume of 13.4 uL; and, a 0.3 mm column has, for example, early eluters with a peak volume of 0.7 uL and late eluters with a peak volume of 2.8 uL. Thus, for example, in some implementations, swappable core units include columns of different ID and associated flow cells of different volumes.

TABLE 2

| Column | Vₚₖ (μL) | Vₚₖ (μL) | V_{cell} (μL) |
|---|---|---|---|
| Diameter (mm) | Early Eluter | Late Eluter | (f = 10) |
| 2.1 | 16 | 39 | 1.6 |
| 1.0 | 3.7 | 13.4 | 0.37 |
| 0.3 | 0.7 | 2.8 | 0.07 |

Merely by way of illustrative example, a UHPLC system, such as an ACQUITY HPLC® system using a 2.1 mm ID column, would desirably have bandspreading of no more than 1 μl, and using a 1.0 mm ID column would desirably have bandspreading of no more than 0.25 μl, to help achieve the resolution potentially offered by the column. Present UHPLC systems, however, may entail bandspreading of, for example, 3 μl, due to in large part to extra-column effects. Thus, some presently available UHPLC systems, as configured and operated, realize substantially none of the potential resolution benefit offered by utilization of a 1.0 mm column. Attempts to shift to shorter columns are also potentially impaired by extra-column band-spreading effects.

Resolution of the system 100 is optionally improved by operation at relatively high retention factors (k). As known by one of skill, with a high retention factor, a column will tend to focus an otherwise dispersed sample plug. FIG. 1B is a graph of measured resolution versus retention factor, for a particular example of the system 100, using an ACQUITY HPLC® apparatus with a 5 cm column (available from Waters Corporation.) The dotted line illustrates the theoretical resolution of the column, which is approximately 14,000 plates. The solid curve shows measured resolution, which illustrates the effect of band-spreading; a substantial reduction in resolution is apparent at retention factors of practical interest, down to approximately k=2, for example.

FIG. 1C is a graph of measured resolution versus retention factor, with the upper solid curve for a 1.7 μm column and the lower solid curve for a 3.5 μm column (i.e., columns packed with particles having diameters, respectively, of 1.7 μm and 3.5 μm.) The upper dashed line is the theoretical resolution of the 1.7 μm column and the lower dashed line is the theoretical resolution of the 3.5 μm. One notes that, at lower retention factors, the 1.7 μm column provides little more resolution than the 3.5 μm column.

Some embodiments provide an alternative to better exploit the benefits of sub-2 μm columns by mating such a column with one or more patterned substrates, thus eliminating or reducing the length of some fluidic pathways and/or cross sections and/or connectors, thus reducing extra-column band spreading and better realizing the potential resolution provided by a particular analytical column. Analysis speed is potentially improved, and the efficiency afforded by presently available high-resolution analytical columns and high-pressure solvent-pump modules is better realized. Some embodiments of the invention, as described below, entail substrate-based fluidic and other components, as implemented, for example, via diffusion bonding of metallic components.

Some preferred embodiments eliminate an injector-to-column tube and related connectors. Such embodiments entail apparatus where such reduction of band spreading is significant relative to the performance the apparatus would otherwise achieve. For example, some embodiments, described below, optionally reduce band spreading from approximately 2.5 μL or approximately 3 μL to approximately 1 μL for a 2.1 mm column and to approximately 0.25 μL for a 1.0 mm column.

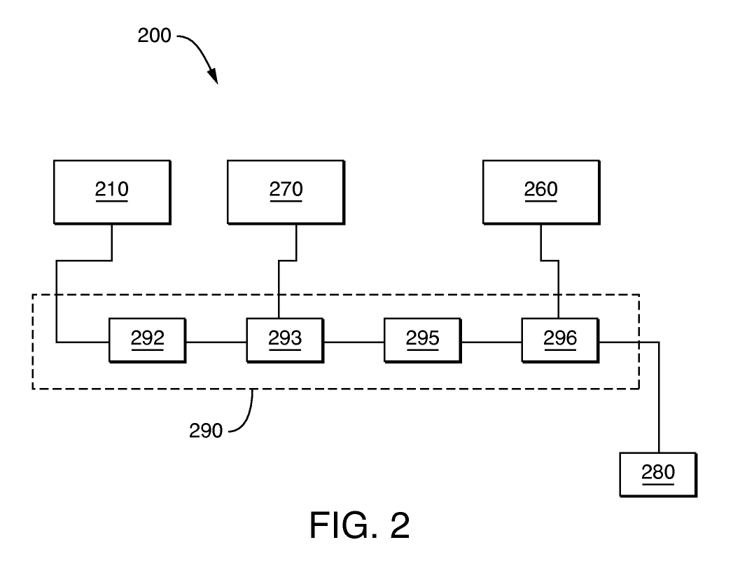

FIG. 2 is a block diagram of a chromatography apparatus 200, according to one embodiment. The apparatus 200 includes a core unit 290, a solvent manager 210, a sample manager 270, a detection unit 260, and a waste collection unit 280. Tubing and associated connectors optionally fluidicly connect the solvent manager 210, a sample manager 270, and the waste collector 280 to the core unit 290.

The core unit 290 includes a solvent mixer 292, a sample injector 293, a separation column 295 and a detection cell 296, such as a flow cell. The detection system 260 is optically connected, in this example, to the detection cell 296. The solvent manager 210 is optionally a HPLC or UHPLC binary or other solvent pumping system, for example, as known to one of skill. Similarly, the sample manager 270 is optionally a known component for delivering a sample to, for example, an injector valve. The detection unit 260 includes components to support optical or other detection of eluent flowing from the column 295. For example, the detection unit 260 is optically connected to the detection cell 296 to deliver light to, and receive light from, the detection cell 296. Thus the combination of the detection unit 260 and flow cell 296 optionally provides UV-absorption analyses of the eluent, as will be understood by one of skill.

The chromatography apparatus 200 is optionally configured to permit swapping of the core unit 290. Thus, different core units supporting, for example, analysis of different types of samples, different flow rates, and/or different sample volumes are exchanged, as desired. Such an apparatus makes better use of components that can be fixed and support a greater range of sample processing or analysis than could any one core.

The core unit 290 is fabricated in any suitable manner, including known manners. For example, the core unit 290 may be, or include, a patterned substrate, and the solvent mixer 292, sample injector 293, separation column 295 and a detection cell 296 may be defined in or attached to ceramic or metallic portions of the unit 290. The core unit 290 is optionally connected to other components 210, 260, 270 of the apparatus 200 via fluidic plumbing, electrical and optical connections, or may utilize a clamping mechanism to ease core swapping.

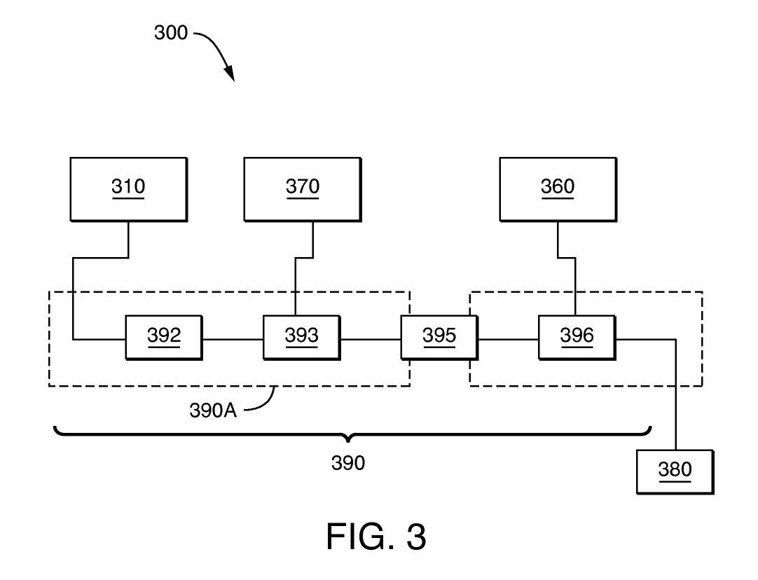

FIG. 3 is a block diagram of a chromatography apparatus 300, according to one embodiment. The apparatus 300 has some similarity to the apparatus 200, described above, however the present apparatus 300 exploits features of tube-based separation columns.

The apparatus 300 includes a core unit 390, a solvent manager 310, a sample manager 370, a detection unit 360, and a waste collection unit 380. Tubing and associated connectors optionally fluidicly connect the solvent manager 310, the sample manager 370, and the waste collector 380 to the core unit 390. The solvent manager 310, the sample manager 370, the waste collector 380 and the detection system are optionally similar to, or identical to, the corresponding components 210, 260, 270 of the apparatus 200.

The core unit 390 includes a sample-delivery patterned substrate 390A, a detection patterned substrate 390B and a tube-based column 395. The sample-delivery patterned substrate 390A has a solvent mixer 392 and a sample injector 393. The sample-delivery patterned substrate 390A optionally has solvent temperature-control features. The detection patterned substrate 390B has a flow cell 396 that works in cooperation with the detection unit 360. The inlet and outlet ends of the column 395 are, respectively, directly connected to an outlet of the sample-delivery patterned substrate 390A and an inlet of the detection patterned substrate 390B. Thus, solvent mixing/conditioning features and sample introduction features are separately integrated with a column interface in one integrated unit 390A while a column-exit interface and detection unit are contained in a second separate integrated unit 390B.

The chromatographic column 395 is preferably tube-based, though optionally substrate based. The column 395 is optionally attached to the integrated units via application of mechanical force, for example, via spring loading and/or other mechanisms. Alternatively, the column 395 is attached via a threaded fitting. Thus, in some embodiments of the invention, integrated components, optionally microfluidic, included in one or more substrates are mated to one or more tube-based columns.

The column 395, as a non-limiting example, has an ID of, for example, 1.0 mm or 2.1 mm and a length of 50 mm, and is packed with 1.7 μm particles. Some features of the apparatus 300 are of increasing benefit as one selects columns with narrower IDs and/or shorter column lengths, and/or for columns of relatively low retention.

Substrates, as noted elsewhere, are optionally fabricated from metallic and/or ceramic layers. Some preferred embodiments utilize diffusion-bonded metallic portions, such as steel and/or titanium portions. Some of such embodiments provide reduced dispersion and higher operating pressures in comparison to some prior modular apparatus.

The effects of non-uniform radial temperature gradients induced by solvent flowing through a packed chromatographic bed can be mitigated by maintaining the column 395 in a temperature-controlled environment, for example, an adiabatic environment. In the apparatus 200, the column is part of a monolithic structure that in some implementations is temperature controlled. For larger column diameters (e.g., >300 μm ID) of some embodiments, better chromatographic performance is optionally obtained if the column is separate from the monolithic device (as, for example, in the apparatus 300) with some or all of the column 395 maintained, for example, in an adiabatic environment.

Furthermore, chromatographic columns are typically considered a consumable because columns typically deteriorate with use. There is thus an alternative, or additional, advantage in separating a column from some, or all, integrated components, to reduce the cost of disposal of a column. Thus, some embodiments advantageously provide replacement of chromatographic separation columns while retaining more expensive integrated bodies that contain, for example, the solvent/sample introduction and detection systems.

The apparatus 200, 300 shown in FIGS. 2 and 3 integrate primary fluidic elements to improve the performance of the chromatographic system by eliminating/reducing the fluidic connections that would normally be made in a modular system. The solvent delivery and sample management modules are still maintained as separate entities that interface to these integrated units. It should be understood that for reasons of cost or further performance enhancements, further integration of either the solvent delivery or sample management modules are optionally made with the integrated device (e.g., integration of the pump heads and/or pressure transducers into the integrated device).

The apparatus 300 is optionally implemented with a swappable column 395 and/or a swappable core unit 390. Thus, the apparatus 300 supports improved chromatographic resolution, realization of resolution afforded by a particular column 395, as well as cost effective use of components of an apparatus that are suitably used in combination with a range of core units that support, for example, different flow rates and/or different sample volumes.

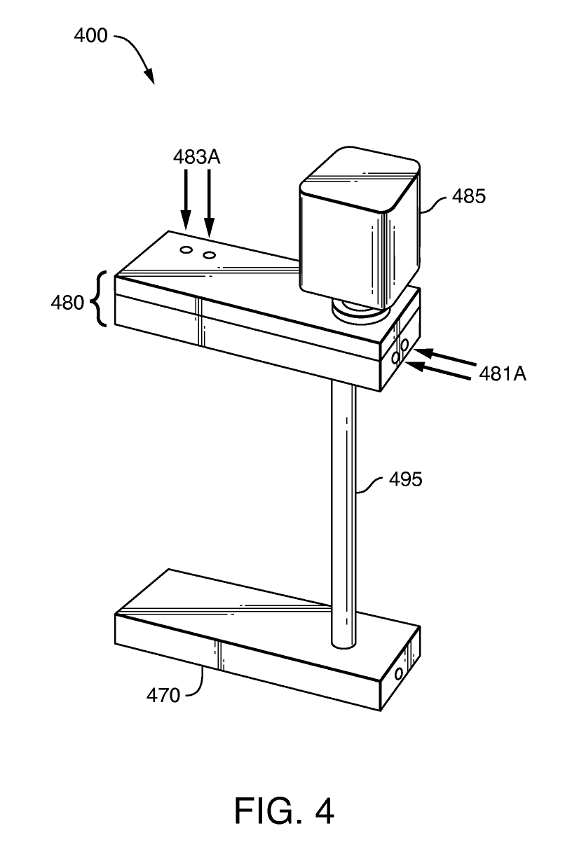

FIG. 4 is a three-dimensional depiction of a more detailed embodiment of a core unit 400, which optionally serves as the core unit 390 of the apparatus 300 illustrated in FIG. 3. The core 400 includes a sample unit 480 (also referred to herein as a sample-delivery patterned substrate,) a sample injector control unit 485, a tube-based separation column 495, and a detection unit 470 (also referred to herein as a detection patterned substrate.)

The sample unit 480 has two solvent inlet ports 483A, for fluidic connection to a binary-solvent-pump module (not shown), and sample inlet and outlet ports 481A, for fluidic connection to a sample-supply module (not shown). The pump module delivers solvent at a pressure that is sufficient for HPLC or UHPLC or higher pressure operation. The sample unit 480 includes a solvent mixer, which receives, and mixes, solvents received via the solvent inlet ports 483A. The sample unit 480 also includes an injector valve in fluidic communication with the mixer, with the sample inlet and outlet ports 481A, and with an injected-sample outlet port that is directly connected to an inlet end of the column 495. The injector valve is, for example, a rotary-shear valve; a sample loop is optionally defined in or attached to the sample unit 480.

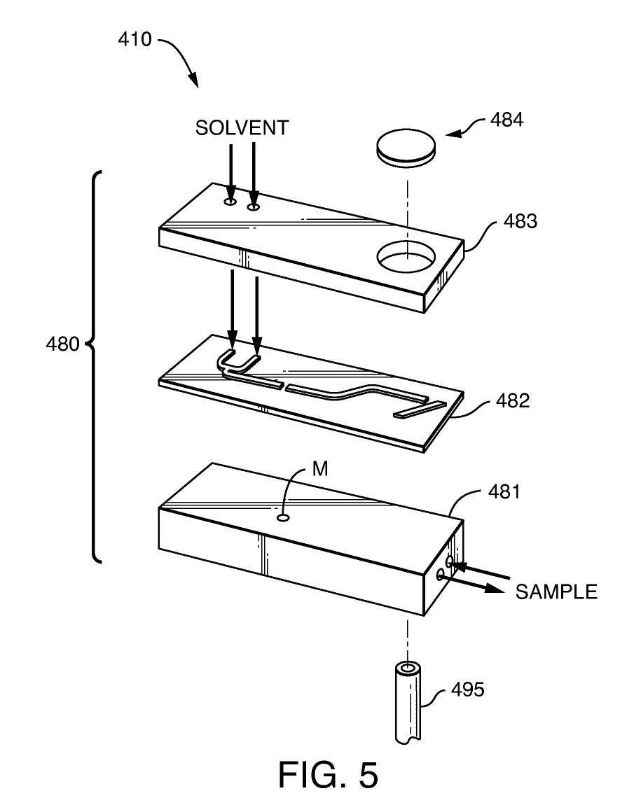

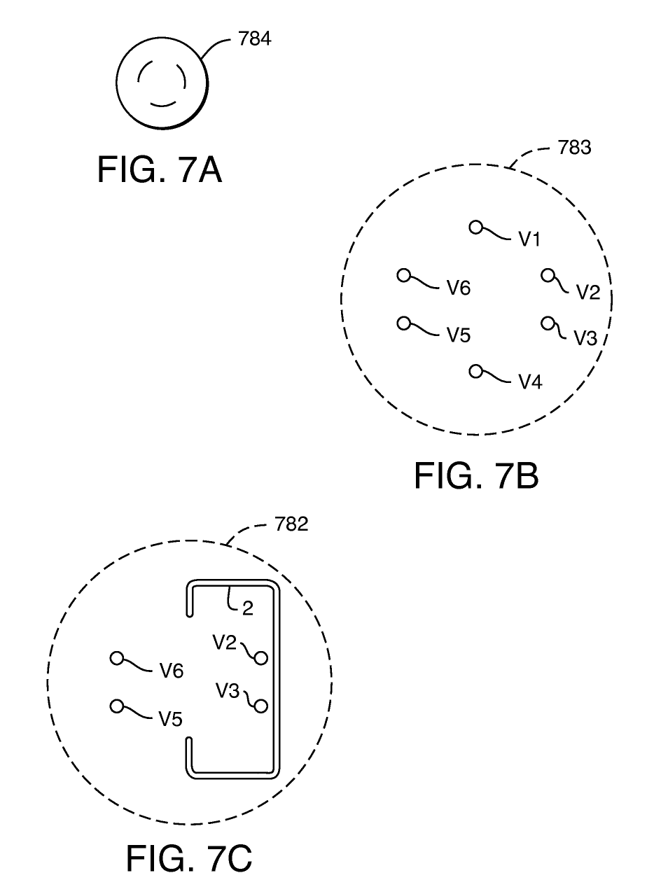

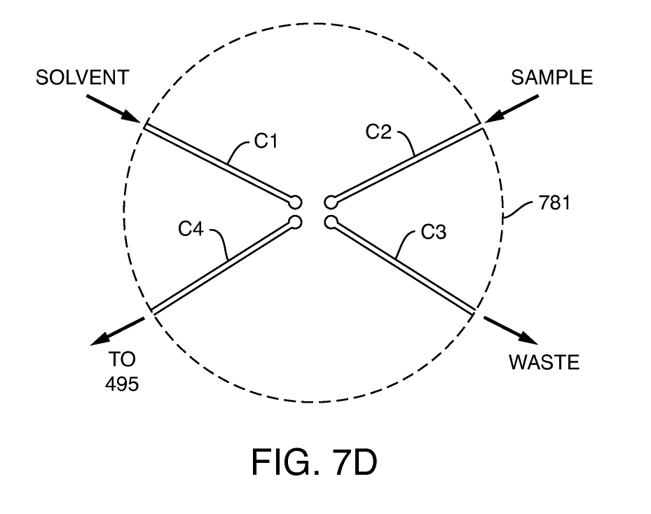

The injector control unit 485 includes, for example, a motor, to control operation of the injector valve. For example, the control unit 485 optionally rotates a rotor of the valve to switch it between load, inject and wash states, as will be understood by one of skill in the chromatography arts. Further details regarding an optional configuration of the sample unit 480 are described below, with reference to FIG. 5 and FIGS. 7A-7D.

The detection unit 470 includes a flow cell or other feature(s) that supports observation of separated compounds that elute from the column 495. In additional, or alternatively, the detection unit 470 delivers a sample to a mass-spectrometry module, for example, via an electrospray outlet interface.

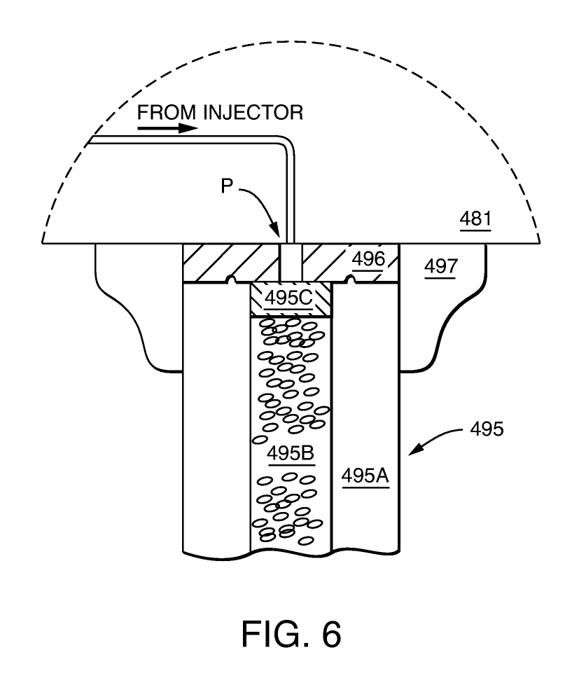

The unit 470 has an eluent inlet port that mates directly with an outlet end of the column 495, and delivers the eluent to the flow cell or other feature(s). The connection of the column 495 to the units 470, 480 is described in more detail with reference to FIG. 6.

The detection unit 470 and the sample unit 480 are preferably formed as patterned substrates. As noted above, patterned substrates are optionally fabricated using diffusion bonding of metallic, preferably titanium, components (as described in PCT International Publication No. WO 2008/106613, inventor Dourdeville, which is incorporated herein by reference in its entirety.)

The core unit 400 is optionally implemented with a swappable or fixed column 495. Moreover, the entire core unit 400 is optionally implemented, in the context of a full chromatography apparatus, as a swappable or fixed unit.

The sample unit 480 is described, next, in more detail.

FIG. 5 is an exploded three-dimensional view of the sample-delivery patterned substrate 480. In this example implementation, the sample unit 480 is formed via diffusion bonding of three primary portions: a first block 481, a foil layer 482 and a second block 483. The three portions are variously patterned.

The first block 481 has a well to provide a solvent mixer M and a conduit connecting the injector valve to the injected-sample outlet port.

The layer 482 is patterned to provide various conduits to connect the solvent inlet ports 483A to the solvent mixer M, the solvent mixer M to the injector valve, and the injector valve to the sample inlet and outlet ports 481A. The layer 482 is also optionally patterned to provide a sample loop.

The second block 483 is patterned with portions of the injector valve, for example, vias that cooperate with the rotor 484 to support switching of the valve state. A particular, merely illustrative, implementation of an injector valve, with an embedded sample loop, is described below with reference to FIGS. 7A-7D.

FIG. 6 is a cross-sectional detailed view of a portion of the apparatus 400 at the inlet end of the column 495. In this example, the column 495 includes a tube 495A, a separation medium 495B in the tube, and a frit 495C to secure the separation medium 495B. The column 495 is directly connected to the first block 481, via a mechanical force, which provides a fluidic seal. An alignment fitting 497 assists alignment of the column 495 with the injected-sample outlet port P of the first block 481 of the sample substrate 480. A deformable gasket 496 is disposed between the frit 495C and the block to assist formation of the fluid-tight seal.

Clamping forces are applied to the core 400 to urge the column 495 towards the sample unit 480. The force provides a greater pressure at the contact interfaces than the fluidic pressure of the sample solution flowing into the column 495.

The gasket 496 is formed of any suitable deformable material, such as a polymer. A suitable polymer is, for example, polyether-ether-ketone, such as PEEK™ polymer (available from Victrex PLC, Lancashire, United Kingdom.)

The gasket 496 has a lumen or fluidic passage aligned with the outlet port P to deliver injected sample solution to the packing medium 495B. Alternative embodiments include, for example, a fluidic component to assist uniform delivery of the sample solution to the packing medium 495B.

Alternative direct interfaces of a column to a sample substrate entail fixed or unfixed connections. For example, the column is permanently attached (e.g., welded), semi-permanently attached (e.g., threaded or press-fit) or easily removable via, for example, a cartridge-type interface.

FIGS. 7A-7D are planar views of a rotor and various patterned layers of an injector valve, in accordance with one alternative embodiment that is optionally implemented in a sample substrate, such as the sample unit 480. FIG. 7A illustrates a rotor 784, having three surface grooves, as will be understood by one of skill in liquid chromatography.

FIG. 7B is a planar schematic view of a portion (indicated by dashed circle) of a stator surface layer 783, for contacting the rotor 784. The layer 783 has six vias V1, V2, V3, V4, V5, V6 (collectively, V) extending through the layer 783. The rotor 784 is positioned against the stator surface layer 783; the orientation of the rotor 784 selects pairs of neighboring vias V for fluidic connection, via the grooves.

FIG. 7C is a planar schematic view of a portion (indicated by dashed circle) of a sample-loop layer 782. The layer 782 is patterned to provide a sample loop L (an example of a sample reservoir chamber) and four vias V2, V3, V5, V6 continuing in alignment with four of the vias V2, V3, V5, V6 of the stator surface layer 783. The two ends of the sample loop L, align with the two remaining vias V1, V4 of the stator surface layer 783.

FIG. 7D illustrates a conduit layer 781, providing four conduits C1, C2, C3, C4 whose ends align with the four vias V2, V3, V5, V6 extending through the sample-loop layer 782. The four conduits C1, C2, C3, C4 support fluidic connections between the injector valve and the solvent mixer M, the injected-sample outlet port P, and the sample inlet and outlet ports 481A.

Operation of an apparatus that includes the core unit 400 is optionally similar to that of a fully modular LC system. Solvent from a solvent manager is delivered to the sample unit 480 where it is mixed and optionally thermally conditioned (i.e., the temperature is controlled by, for example, equilibration in the sample unit 480, or a more active technique) and delivered to the chromatographic column 495. A sample manager optionally delivers sample to the sample unit 480. Any suitable solvent manager and sample manager may be used, including commercially available modules (as available from Waters Corporation, Milford, Mass.)

Fluidic features of very small dimensions (i.e. typically <100 μm, potentially <10 μm, or even smaller) are optionally utilized in embodiments of partially integrated devices (fabricated, for example, prior to diffusion bonding using techniques such as chemical etching, electrochemical micromachining, electric discharge machining, etc.)

As described above, preferred embodiments help to realize the potential resolution afforded by analytical columns that utilize small particle sizes and are operated at high pressures; as described above, the potential resolution of a high-pressure system employing such a column is particularly impaired for narrower columns. Narrower columns, however, are generally easier to cool (higher surface-to-area ratio) and support a “green” interest in use of lesser quantities of solvent.

Some of these preferred embodiments entail a microbore-scale column packed with particles of diameter less than 2 μm. For example, one suitable analytical column, which includes 1.7 μm diameter ethylene bridged hybrid particles, is an ACQUITY HPLC® BEH TECHNOLOGY™ column (available from Waters Corporation, Milford, Mass.) The column's ID is, for example, in a range of approximately 1 mm to approximately 2 mm. Thus, the core unit 400 provides reduced use of solvent, better realization of the potential resolution offered by the column 495, and swapping of core units to accommodate a greater variety of sample separations with one apparatus.

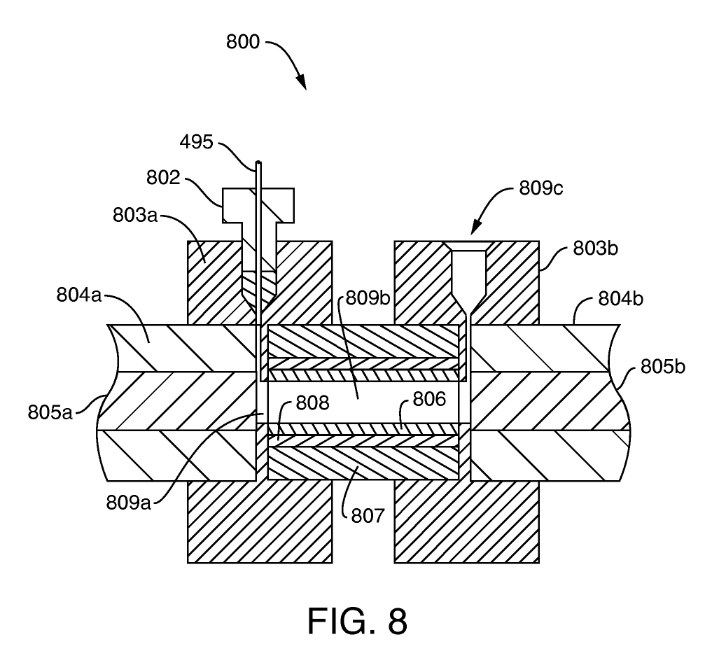

Next referring to FIG. 8, the detection unit 470, of the apparatus core unit 400, supports observation of sample eluent. The partially integrated, low-dispersion chromatographic apparatus that includes the core unit 400, utilizes a detection process to measure, for example, a physical property of the one or more analytes eluting from the column 495. The measurement process preferably provides identification and/or quantification of the analytes.

Various components provide detection, some of which are provided by the detection unit 470. The detection unit 470 includes an interface between the eluent stream exiting the column 495 and other detection components. As used herein, the term “detector” means a component that contains or otherwise directly interacts with an eluent to interogate the eluent, for example, regarding composition of the eluent. Thus, two examples of detectors are: 1) an optical-based flow cell; and 2) an electrical-based cell having a component that makes electrical contact to the eluent for conductivity measurements.

Preferred embodiments include a detector in a unit that is directly coupled to a chromatography column; some of these embodiments distribute components of a detection system, for example, the detector is part of the unit attached to the column, and electronics and/or other detection system components are remotely disposed and need not be integrated in a patterned unit.

For example, in the case of an optical-based sensor, the detection unit 470 optionally includes features that provide optical interrogation of the column eluent. In this context, the interrogation is implemented by launching light into, and collecting light from, for example, a sample/flow cell. In absorbance or RI based measurements, the launched and collected light optionally involves manipulation of just one primary beam while for some techniques, such as fluorescence, Raman, light scattering, etc., light collection is preferably performed along a physical path distinct from the excitation probe.

In some variations of photothermal detection, only an excitation beam is required, with detection carried out by a transduction method, such as conductivity. As a primary detection means, electrical conductivity will generally require only an electrical interface to a detection system (such as the system 360.) In some embodiments, the detection unit 470 has a calibration-sample inlet, to provide introduction of calibration standards or other solutions, which might normally adversely affect a column packing material.

Some alternative embodiments support multiple detection methods. For example, an eluent optionally passes through a flow cell for light detection and then proceeds to a spray outlet for delivery to a mass-spectrometry module. Alternatively, the eluent stream is split for multiple types of detection using one or more detection substrates. Thus, a detection unit optionally employs mass spectrometry, light scattering or, for example, chemiluminescence. A stream exiting a column is optionally nebulized, volatilized, mixed with other chemicals, or in other ways modified before entering a detection zone or cell. Such intervening steps or transformations are optionally implemented in the same or different substrates or sub-blocks, each dedicated to a particular functional requirement of the sample transformation, or optionally performing multiple steps. Such post-column steps optionally include: flow splitting, for example, to regulate flow between multiple flow paths leading to more than one detection channel; flow mixing, either liquid or gas, either for post-column chemical reactions or nebulization; and pre-detection thermal or pressure regulation, which is optionally integrated with a detector, such as an optical-detection flow cell.

Additional modules are optionally included after a detection unit. Some such modules are optionally similar to modules preceeding detection (e.g., post-detection back-pressure regulation in supercritical fluid chromatography (SFC),) or are optionally associated with secondary detection steps such as UV-directed fraction collection.

As noted, the detection unit 470 optionally includes a detector or measurement cell that is physically removed from other components of a detection system. Thus, optionally, a cell, included in the detection unit 470, is fluidically coupled to the column 495 and remotely coupled via optical links to remaining detector-system components via an optical link(s), for example, an optical fiber(s). A distributed detector system is advantageous, for example, in situations where the fluid exiting the column 495 and passing through the cell could lead to excessive thermal rises within a non-distributed, traditional detection system. Typical features of some prior art detection systems, which optionally warrant a distributed configuration, are sensitive electronics and/or opto-mechanical elements that have an unfavorable thermal sensitivity.

A particular example of a flow-cell configuration and its fabrication are described next, merely to illustrate one optional embodiment. FIG. 8 is a cross-sectional view of a flow-cell portion of one alternative implementation of the detection unit 470, which supports absorbance-based optical analysis.

The detection unit 470, in this example, has an entrance fluidic path 809a, a chamber 809b, and an exit fluidic path 809c. The column 495 is sealed directly to an inlet element 803a via a conventional nut/ferrule fastener 802. Light is introduced into the sample chamber 809b via an optical fiber 805a secured in a fluid-tight sleeve 804a. The fluid-tight sleeve 804a is sealed into the inlet element 803a via, for example, a face and/or edge seal; a mating surface of the fluid-tight sleeve 804a is optionally coated with a compliant or resilient material.

The sample chamber 809b is defined by an inner member 806, which is preferably formed of a material whose refractive index is less than that of the fluid passing through the chamber 809b. The tube 806 is optionally sleeved within another tubular member 808 for purposes of securing the two tubes 806, 809b within a housing 807, which, in turn, is fluidically sealed to the inlet element 803a.

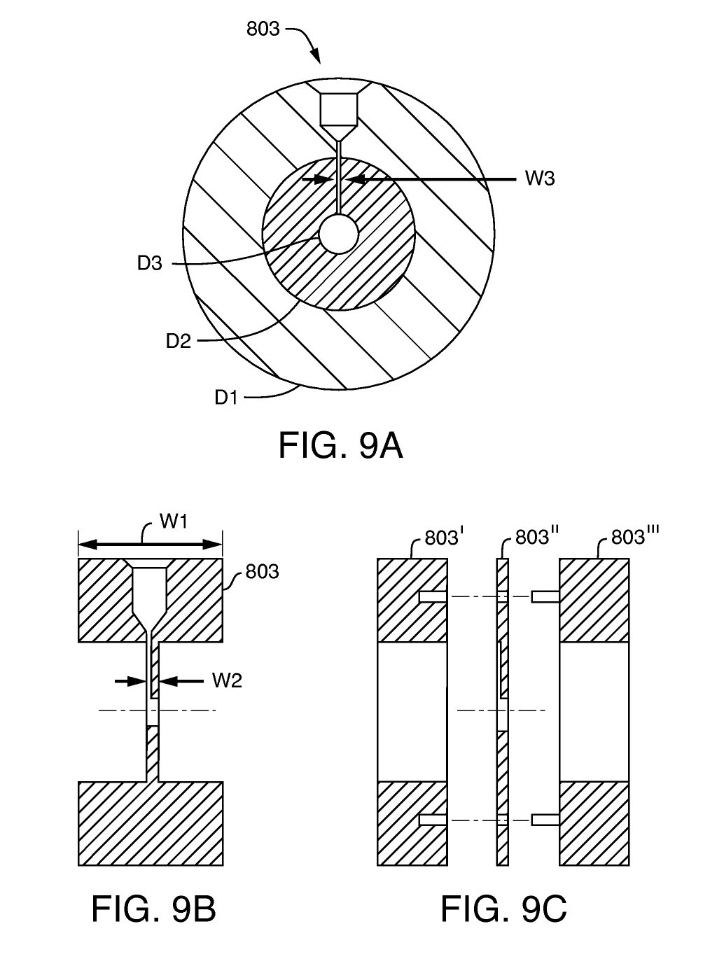

An outlet element 803b is similarly sealed to an opposite end of the housing or tube 807. The outlet element 803b is also sealed to outlet-associated components 804b, 805b that correspond to the inlet-associated fluid-tight sleeve 804a and the optical fiber 805a. The outlet and inlet elements 803b, 803a are described in more detail with reference to FIGS. 9A, 9B and 9C.

Alternatively, the member 806 is an optically transmitting material whose refractive index is greater than that of the fluid, such as fused silica or sapphire, while the tubular member 808 is formed of an optically transmitting material brought into intimate contact with the member 806 and whose refractive index is less than that of the fluid. One example material with a suitable refractive index is an amorphous fluoropolymer such as TEFLON® AF2400 amorphous fluoropolymer (available from DuPont Engineering Polymers, Newark, Del.)

Alternatively, the inner member 806 is coated with a low index material, for example, applied to the member 808; preferably, the coating thickness is several wavelengths of the longest wavelength of use contemplated. For example, the coating thickness is several micrometers for use within a wavelength range of 100 to 1,000 nanometers. In such cases, the member 808 need not be optically transmissive, but preferably is substantially smooth and has a physically durable union or interface with the coated material. Similarly, the member 808 optionally is coated, adjacent to the optically transmissive member 86. Optionally, the outer member 808 is further enclosed or encapsulated with an inert material or coating.

FIGS. 9A and 9B are, respectively, end and side views of an inlet or outlet element 803, which illustrate an optional configuration and fabrication method, as well as dimensions of the elements 803a, 803b. For non-limiting illustrative purposes, the outer diameter (OD) D1 of the fluid-tight sleeve 804a is, for example, approximately 25 mm, its ID D2 is, for example, in a range of less than 1 mm to approximately 10 mm, and the diameter D3 of the chamber 809a is less than 50 μm to approximately 0.5 mm. The thickness W1 of the external portion of the element 803 (the length along the axis of the cell) is, for example, approximately 10-20 mm, while the inner portion has a thickness W2, for example, of, approximately 25 μm to 150 μm. The width W3 of the channel connecting the column 495 to the sample chamber 809b is, for example, approximately 25 μm to 150 μm.

Conventional machining methods are generally poorly suited to the fine dimensional and surface-quality control desired for present purposes. Preferably, at least some fluidic pathways are defined with non-machining methods, such as chemical etching, laser etching, plasma etching, ion-beam milling, etc. The fabrication of the element 803 optionally entails diffusion bonding. Patterning and diffusion bonding are performed in any suitable manner, for example, as described in PCT International Publication No. WO 2008/106613, inventor Dourdeville.

FIG. 9C illustrates fabrication of the element 803 via diffusion bonding of three metallic components 803′, 803″, 803″′. The element is formed of a sandwich of two relatively thick portions 803′, 803″′ sandwiching the thinner portion 803″. The middle, thinner portion 803″ has an etched groove and a central aperture. Registration features, such as the illustrated dowel-and-pin engagements, optionally assist alignment during subsequent diffusion bonding.

Merely for illustrative purposes, assuming the etched groove provides a channel of 0.156″ or 4 mm in length, 0.0015″ or 0.038 mm in depth, 0.010″ or 0.25 mm in widith, the channel has a volume Vᵢₙ of 40 nanoliters (0.04 μL). In turn, assuming the cell chamber is sized for separations employing column diameters in the first or second rows of Table 2, the fluid path volume Vᵢₙ from the column 495 outlet to chamber inlet is approximately 100 times less than the cell volume.

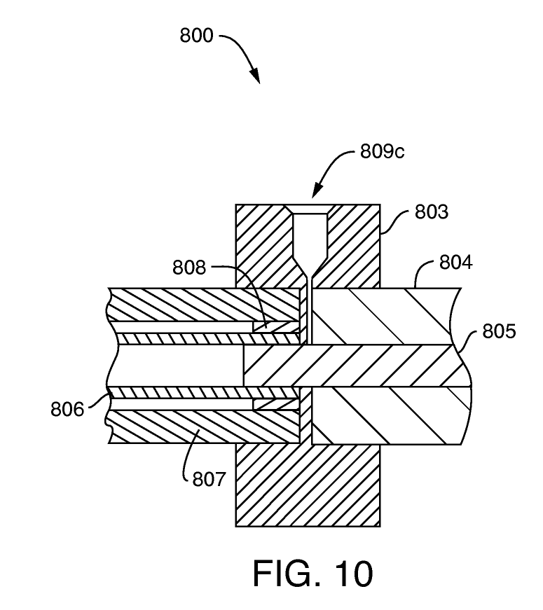

FIG. 10 is a cross-sectional view of an output end of the above-described flow cell, with an alternative fiber-optic coupling. In this configuration, an optical fiber 805a extends into the sample chamber 809b. A similar arrangement is optionally utilized at the input side. In this arrangement, the fiber at the inlet causes fluid to flow through an annular section created between the fiber and the member 806, eventually entering the full chamber 809b. Such a flow path adds a trivial amount of uninterrogated fluid while promoting an even flow and sweeping out of the sample.

As a further alternative, the outer member 808 extends only a short distance from the input and exit ends of the inner member 806. The inner member 806 then serves to fluidically seal a gap between the inner member 806 and the tube 807. The gap, filled, for example, with air, has a refractive index that is only slightly greater than 1.00 throughout a range of wavelengths of interest. Such a configuration provides a fluid core waveguide of high numerical aperture.

As a general matter, one of skill will recognize that light may be arranged to enter a cell from a same side as that which fluid enters. Further, for example, an optical interface at one end may be different than at another end; for example, a cell may utilize an optical-fiber-based input and a lensed-based-output, or any combination thereof.

As noted, above, alternative detection methods are implemented in various alternative embodiments. Such methods include, for example, fluorescence or Raman measurements. In these cases, the wavelength range of light introduced into, for example, a sample chamber or flow cell lumen, is preferably relatively narrow. Light is provided from, for example, a spectrally-filtered broad-band lamp, a filtered or unfiltered LED or a laser. Light is optionally collected by an optical element disposed at an opposite end of a sample chamber.

One benefit afforded by a wave-guide-based excitation-emission analysis is that the effective pathlength for both absorption and emission is increased and further that the light collection angle, defined by the numerical aperture of the waveguide, can be relatively large. In the case of Raman, the collection optics preferably contain a minimum length of an optical fiber or a collection of discrete optics such as a window for minimizing the excitation of Raman features associated with the fiber, window or lensed material, as the effects of such material can dominate or obscure those due to the analytes of interest.

Some preferred embodiments of the invention entail apparatus of reduced cost and size relative to existing apparatus, such as existing analytical equipment based on LC-MS. Miniaturization provides many potential benefits in addition to size reduction, for example: improving reliability; reducing the quantity and cost of reagents, and the cost of used-reagent disposal; and improved performance in reducing dispersion in LC-related components. While preferred embodiments, described herein, relate to liquid chromatography, one of skill will recognize that the invention may be applied to other separation techniques.

While the invention has been shown and described with reference to specific preferred embodiments, it should be understood by those of ordinary skilled in the art that various changes in form and detail may be made therein without departing from the scope of the invention as defined by the following claims. For example, a detection unit optionally utilizes lenses, with or without fiber optics, to communicate light into and/or out of an interrogated fluid. Moreover, while the flow cell of FIGS. 8, 9A, 9B and 9C has a cylindrical configuration, alternative embodiments have alternative configurations, such as a rectangular-solid configurations. Alternatively, for example, light-collection pathways are orthogonal to the long axis of the chamber 809b. In such cases, the additional pathway optionally provides an optical window into the chamber 809b, but otherwise is unobtrusive with regard to flow through the chamber, thus preserving a low-dispersion detection volume.

What is claimed is:

1. A chromatography apparatus, comprising:
a sample-delivery patterned substrate comprising an injector valve and a sample outlet port in fluidic communication with the injector valve; and
a separation column comprising a tube and a stationary medium in the tube, and having an inlet end portion directly connected to the sample outlet port of the patterned substrate.

2. The apparatus of claim 1, further comprising a detection patterned substrate comprising a detector and an eluent inlet port in fluidic communication with an inlet of the detector, wherein an outlet end portion of the tube is directly connected to the eluent inlet port of the detector patterned substrate.

3. The apparatus of claim 2, wherein the sample-delivery patterned substrate comprises diffusion-bonded metallic portions, and the detector patterned substrate comprises diffusion-bonded metallic portions.

4. The apparatus of claim 1, wherein the stationary medium comprises particles having a diameter of less than about 2.0 μm.

5. The apparatus of claim 4, further comprising a solvent pumping unit having an operating pressure of greater than about 15,000 psi, wherein the solvent pumping unit is in fluid communication with a solvent inlet port of the sample-delivery patterned substrate, for delivery of a solvent to the injector valve.

6. The apparatus of claim 5, where the sample-delivery patterned substrate further defines a solvent mixer in fluidic communication with the solvent inlet port and the injector valve, to deliver mixed solvent to the injector valve.

7. The apparatus of claim 1, wherein the inlet end portion of the tube of the separation column is removably attached to the outlet port of the substrate.

8. The apparatus of claim 7, wherein the inlet end of the tube of the separation column is threadably attached to the outlet port of the substrate.

9. The apparatus of claim 1, wherein the tube has an inner diameter of about 2 mm or less.

10. The apparatus of claim 9, wherein the inner diameter of the tube is about 1 mm or less.

11. The apparatus of claim 10, wherein the inner diameter of the tube is about 0.3 mm or less.

12. The apparatus of claim 1, wherein the sample delivery patterned substrate defines a sample reservoir chamber for loading of a sample that is to be injected onto the chromatographic column.

13. The apparatus of claim 12, wherein the sample delivery patterned substrate has a sample inlet port in fluidic communication with the injector valve, and further comprising a sample-management module in fluidic communication with the sample inlet port of the sample delivery patterned substrate, to deliver a sample to the injector valve for loading into the sample reservoir chamber.

14. The apparatus of claim 1, wherein the injector valve comprises a rotor rotatably disposed against a stator surface of the substrate.

15. The apparatus of claim 1, wherein the sample-delivery patterned substrate comprises a ceramic material.

16. The apparatus of claim 1, wherein the detector patterned substrate comprises a ceramic material.
